(19) United States
(12) Patent Application Publication
(10) Pub. No.: US 2004/0020330 A1
(43) Pub. Date: Feb. 5, 2004

(54) Wrench having a hollow handle

(76) Inventor: Bobby Hu, Taichung (TW)

Correspondence Address: Alan D. Kamrath, Rider Bennett, LLP, Suite 2000, 333 South Seventh Street, Minneapolis, MN, 55402, US

(21) Appl. No.: 10/623,903

(22) Filed: Jul. 21, 2003

(30) Foreign Application Priority Data
Aug. 5, 2002 (TW) 91117728

(51) Int. Cl. B25B 23/16

(52) U.S. Cl. 81/177.1

(57) ABSTRACT

A wrench includes a hollow handle and a head. The hollow handle has a first, necked end and a second end. The first, necked end has a diameter smaller than that of the second end of the hollow handle. The second end of the hollow handle has an integral end wall for at least partially closing the second end of the hollow handle. The head and the necked end of the hollow handle are fused together.

### BACKGROUND OF THE INVENTION

1. Field of the Invention

The present invention relates to a wrench having a hollow handle.

2. Description of the Related Art

Ratchet wrenches have been widely used for tightening/loosening fasteners with or without the use of sockets. The handle of a typical ratchet wrench is formed by means of carrying out a “hot forging” process on a solid iron raw material, resulting in a solid weighty structure that is a burden to the user, which is particularly true for a large size handle. Further, stress concentration occurs easily during the forging process of the solid handle of iron, providing a weaker structure incapable of withstanding higher bending moment. Further, the manufacturing cost of the solid handle requiring a large amount of material is relatively high, and the stock cost is expensive, as production of at least twenty thousand pieces is usually required for each solid handle forging mold.

An example of forming a solid handle of a ratchet wrench is disclosed in, e.g., Taiwan Patent Publication No. 153538, in which a plate is processed to form a wrench having a solid handle, a head with a hole, and a necked portion. Another conventional method for manufacturing a wrench includes directly forging a wrench having a solid handle and a head. As mentioned above, the cost is high, and the overall weight is relatively large, causing a burden to the user. Further, it was found that the maximum torque-bearing capacity of a solid rod is smaller than that for a hollow tube, where the cross-sectional area is the same. Thus, the present invention is intended to provide a method for manufacturing a wrench having a hollow handle for mitigating/obviating the above problems.

U.S. Patent Publication No. US 2002/0035899 A1 discloses a socket wrench having a tapered hollow handle and a set of sockets stored together in a plastic tapered tray which fits within a hollowed portion of the tapered hollow handle. A cap is placed at the end of the handle to hold the tray and the sockets in position. The overall weight of the wrench is still considerably large. Further, the cap might be lost and thus cause inconvenience during use of the wrench.

### SUMMARY OF THE INVENTION

A wrench in accordance with the present invention includes a hollow handle and a head. The hollow handle has a first, necked end and a second end. The first, necked end has a diameter smaller than that of the second end of the hollow handle. The second end of the hollow handle has an integral end wall for at least partially closing the second end of the hollow handle. The head and the necked end of the hollow handle are fused together.

The overall weight of the wrench thus manufactured is relatively small when compared with a wrench having a solid handle. The burden to the user operating the wrench for a relatively long period of time is greatly reduced, and the working efficiency is improved. Further, the impact-resistance, toughness, and strength of the wrench having a hollow handle are improved.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart illustrating a method for manufacturing a wrench in accordance with the present invention.

FIGS. 2A through 2E are views illustrating manufacture of a wrench by the method shown in FIG. 1.

FIG. 3 is a perspective view of a wrench manufactured by the method in accordance with the present invention.

FIG. 4 is a flowchart illustrating a modified embodiment of the method for manufacturing a wrench in accordance with the present invention.

FIGS. 5A through 5E are views illustrating manufacture of a wrench by the method shown in FIG. 4.

FIG. 6 is a partial sectional view illustrating a modified embodiment of the wrench in accordance with the present invention.

FIG. 7 is a partial sectional view illustrating another modified embodiment of the wrench in accordance with the present invention.

### DETAILED DESCRIPTION OF THE PREFERRED EMBODIMENTS

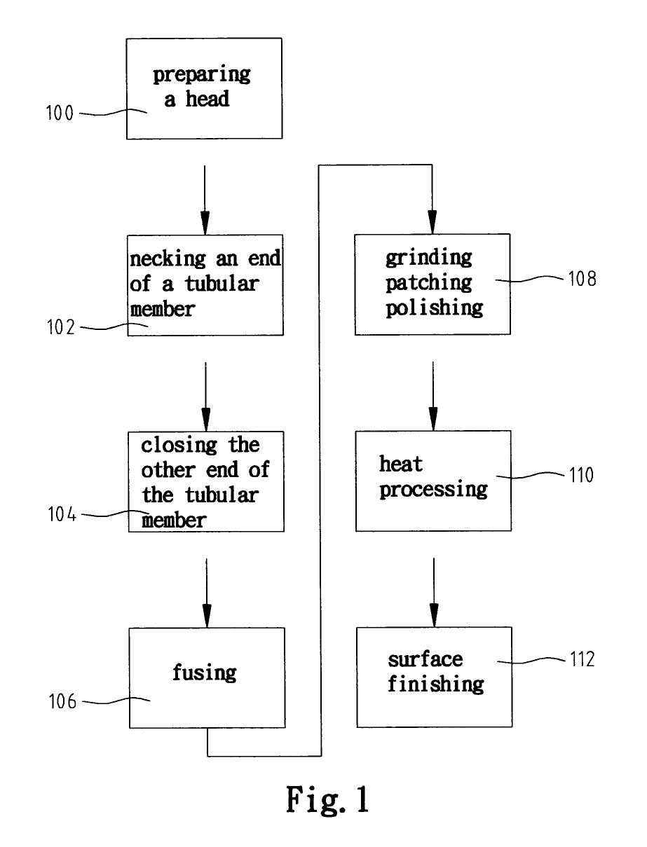

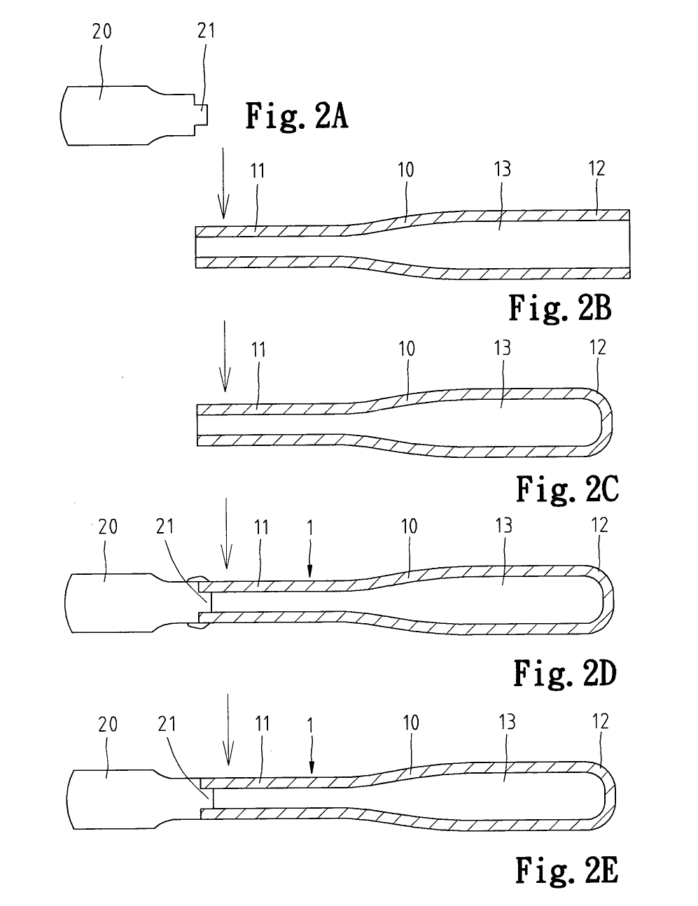

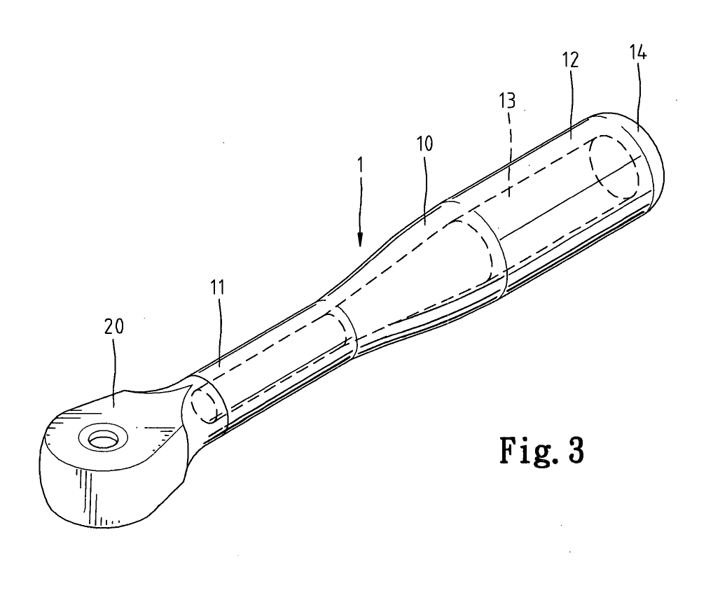

Referring to FIG. 3, a wrench 1 in accordance with the present invention generally comprises a head 20 and a hollow handle 10. The wrench can be manufactured by a method shown in FIGS. 1 and 2A-2E. The method for manufacturing a wrench in accordance with the present invention comprises: preparing a head 20 having an engaging portion 21 (step 100 and FIG. 2A), necking an end 11 of a metal tubular member 10 that has a hollow interior 13 (step 102 and FIG. 2B), closing the other end 12 of the metal tubular member 10 (step 104 and FIG. 2C), fusing the end 11 of the metal tubular member 10 and the head 20 together (step 106 and FIG. 2D), grinding, patching, and polishing an outer periphery of the tubular member 10 to provide a smooth surface (step 108), heat processing the tubular member 10, rendering a uniform hardness in the bending portions, joint portions, and the remaining portions of the tubular member 10 and thus providing improved strength and hardness for the tubular member 10 (step 110), and surface finishing the tubular member 10 (step 112 and FIG. 2E). The surface finishing process includes vibration treatment, sanding, and/or electroplating.

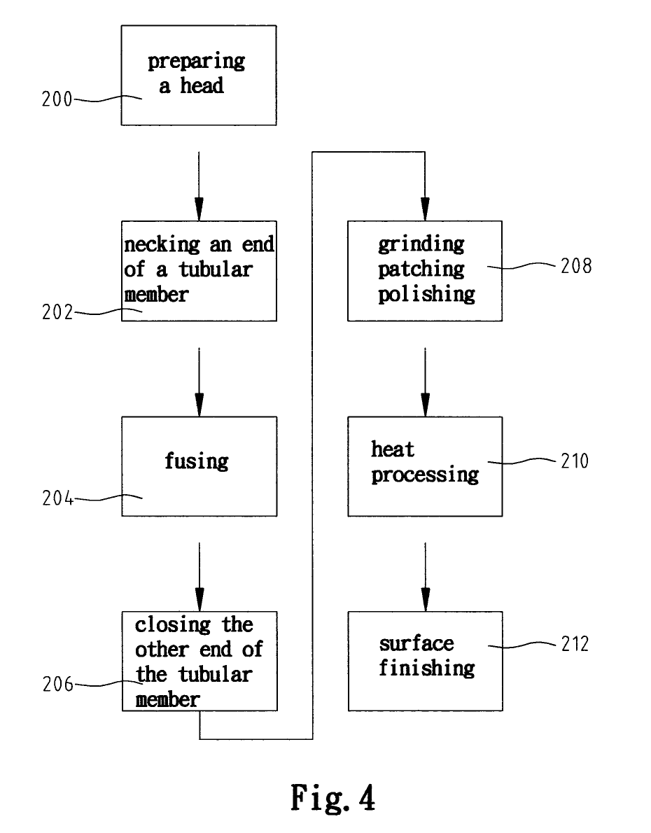

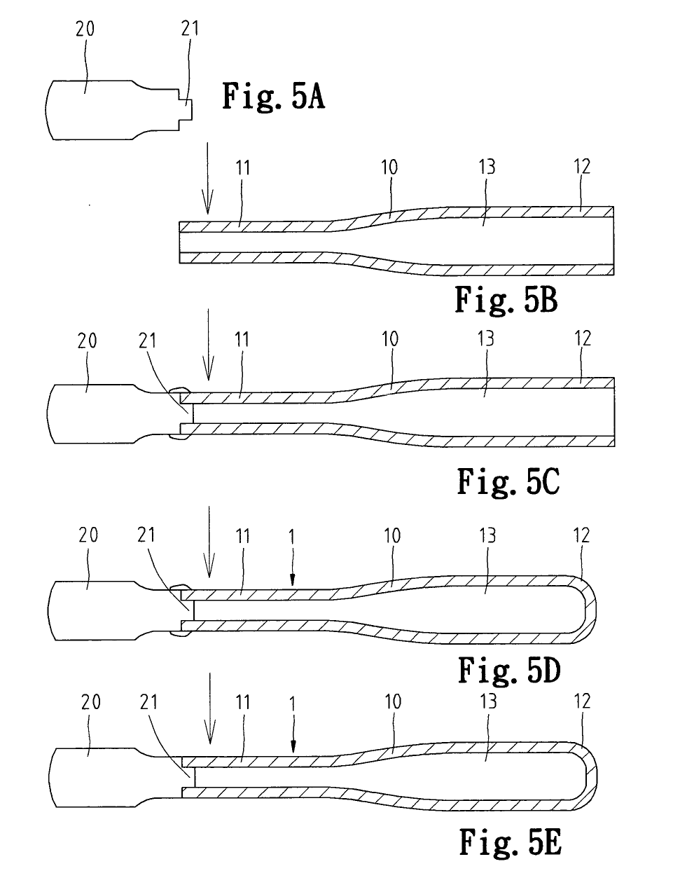

Referring to FIGS. 4 and 5A-5E, another method for manufacturing a wrench in accordance with the present invention comprises: preparing a head 20 having an engaging portion 21 (step 200 and FIG. 5A), necking an end 11 of a metal tubular member 10 that has a hollow interior 13 (step 202 and FIG. 5B), fusing the end 11 of the metal tubular member 10 and the head 20 together (step 204 and FIG. 2C), closing the other end 12 of the metal tubular member 10 (step 206 and FIG. 2D), grinding, patching, and polishing an outer periphery of the tubular member 10 to provide a smooth surface (step 208), heat processing the tubular member 10, rendering a uniform hardness in the bending portions, joint portions, and the remaining portions of the tubular member 10 and thus providing improved strength and hardness for the tubular member 10 (step 210), and surface finishing the tubular member 10 (step 212 and FIG. 5E). The surface finishing process includes vibration treatment, sanding, and/or electroplating.

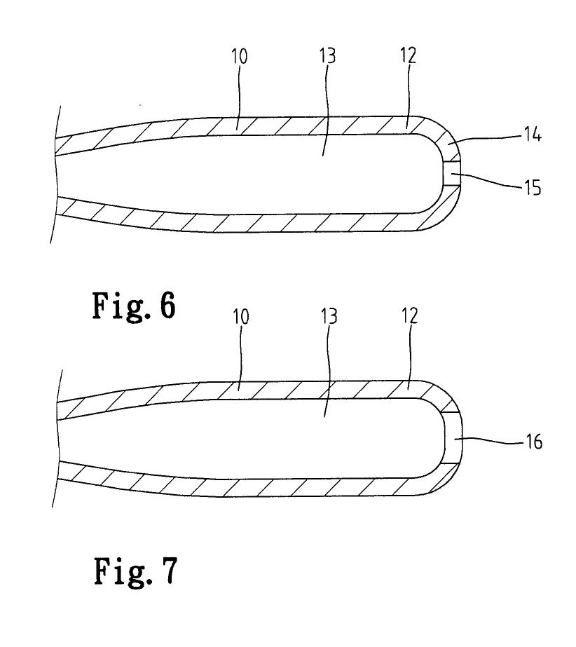

Referring to FIG. 3, the wrench 1 in accordance with the present invention comprises a hollow handle 10 and a head 20. The hollow handle 10 has a first, necked end 11 and a second end 12. The first, necked end 11 has a diameter smaller than that of the second end 12 of the hollow handle 10. The second end 12 of the hollow handle 10 has an integral end wall 14 for at least partially closing the second end 12 of the hollow handle 10. Namely, the integral end wall 14 is made of a material the same as that for forming the hollow handle 10. The head 20 and the necked end 11 of the hollow handle 10 are fused together. In this embodiment, the integral end wall 14 completely closes the second end 12 of the hollow handle 10, as shown in FIG. 3. FIG. 6 shows a modified embodiment of the wrench, wherein the integral end wall 14 of the second end 12 of the hollow handle 10 has a small opening 15. FIG. 7 shows another modified embodiment of the wrench, wherein the integral end wall 14 of the second end 12 of the hollow handle 10 has a large opening 16.

The overall weight of the wrench 1 is relatively small when compared with a wrench having a solid handle. The burden to the user operating the wrench for a relatively long period of time is greatly reduced, and the working efficiency is improved regardless of the age and sex of the user. Further, it was found that the impact-resistance, toughness, and strength of the wrench 1 having a hollow handle were better than those of a wrench having a solid handle, where the cross-sectional solid area is the same, while reducing the manufacturing cost of the wrench.

Although the invention has been explained in relation to its preferred embodiment, it is to be understood that many other possible modifications and variations can be made without departing from the scope of the invention as hereinafter claimed.

What is claimed is:

1. A wrench comprising a hollow handle and a head, the hollow handle having a first, necked end and a second end, the first, necked end having a diameter smaller than that of the second end of the hollow handle, the second end of the hollow handle having an integral end wall for at least partially closing the second end of the hollow handle, the head and the necked end of the hollow handle being fused together.

2. The wrench as claimed in claim 1, wherein the second end of the hollow handle is completely closed.
